(19) United States
(12) Patent Application Publication
(10) Pub. No.: US 2025/0322187 A1
(43) Pub. Date: Oct. 16, 2025

(54) Optical Sensor

(71) Applicant: Leuze electronic GmbH + Co. KG, Owen/Teck (DE)

(72) Inventors: Jörg Droemer, Bad Urach-Wittlingen (DE); Reza Kharrazian, Reutlingen (DE); Thomas Dümmel, Hülben (DE)

(21) Appl. No.: 19/174,977

(22) Filed: Apr. 10, 2025

(30) Foreign Application Priority Data
Apr. 14, 2024 (DE) 202024101838.9

(51) Int. Cl. G06K 7/10; H04N 23/54; H04N 23/55

(52) U.S. Cl. CPC G06K 7/10831; H04N 23/54; H04N 23/55

(57) ABSTRACT

An optical sensor for detecting objects, with a housing in which electronic components and at least one sensor component are mounted. At least one of the electronic components generates an output signal in dependence upon sensor signals of the sensor component or a sensor component. A printed circuit board is present as electronic component, wherein the sensor component is arranged lying in a tube on a side forming an assembly side. The tube is fastened with fastening means that are all arranged on or at the assembly side and are mountable on the assembly side.

### CROSS REFERENCE TO RELATED APPLICATIONS

This application claims the priority of DE 202024101838.9 filed on 2024 Apr. 15; this application is incorporated by reference herein in its entirety.

### BACKGROUND

The invention relates to an optical sensor.

Such optical sensors are generally used for detecting objects. For this purpose, the optical sensor has sensor components and electronic components integrated in a housing.

The optical sensor typically has a light beam-emitting transmitter unit and a receiver unit which receives light beams reflected back by an object.

At least one electronic component forms an evaluation unit in which an output signal is generated in dependence upon sensor signals of the sensor components.

The optical sensor can be used for detecting objects within a monitoring area. In this case, as the output signal, the optical sensor generates an object detection signal that signals whether an object is present in the monitoring area, or not.

The optical sensor can be used also to detect codes, in particular, such as e.g. barcodes or 2D codes, i.e. the optical sensor then forms a code reader. In this case, the code information contained in the sensor signals of the sensor components is decoded in the evaluation unit, such that the detected code can be output as the output signal.

With an embodiment in the form of a code reader, in particular, the receiver unit is designed in the form of an image sensor, i.e. an imager. Advantageously, a transmitter unit in the form of an illumination unit having, for example, a multiple arrangement of light-emitting diodes, is assigned to the image sensor.

A lens, mounted in a tube, is typically arranged in front of the image sensor.

The image sensor is arranged on one side of a printed circuit board. For mounting the tube, it must be fastened on the same side of the printed circuit board, such that the image sensor lies inside the tube and the lens is arranged in front of the image sensor.

In known optical sensors, the tube is fastened to the printed circuit board with screws. The screws pass through boreholes in the printed circuit board, wherein the ends of the screws open out on the opposite side of the printed circuit board and may be fixed there, as the case may be. In similar fashion, latching hooks can be provided as fastening means for the tube, the latching hooks also passing through boreholes in the printed circuit board, wherein the ends of the latching hooks project beyond the opposite side of the printed circuit board and are latched there.

Such mounting then becomes problematic or not executable when the tube with the image sensor is to be arranged on one side of the printed circuit board and the opposite side forms a component side on which multiple components, i.e. electronic components, must be placed. A large-area computer unit, in particular, such as e.g. a microcontroller that forms the evaluation unit of the optical sensor, can be among these electronic components.

To minimize or prevent transmission disturbances on lines used for data transmission that connect the image sensor to the microcontroller, these lines should be kept as short as possible. To achieve this, the microcontroller should be placed opposite the image sensor on the printed circuit board.

In such configurations, the space needed for fastening means of the tube, or respectively for an actuation of the fastening means, is lacking on the component side of the printed circuit board.

### SUMMARY

The invention relates to an optical sensor (1) for detecting objects, with a housing (2) in which electronic components and at least one sensor component are mounted. At least one of the electronic components generates an output signal in dependence upon sensor signals of the sensor component or a sensor component. A printed circuit board (3) is present as electronic component, wherein the sensor component is arranged lying in a tube (6) on a side forming an assembly side. The tube (6) is fastened with fastening means that are all arranged on or at the assembly side and are mountable on the assembly side.

### DETAILED DESCRIPTION

The problem which the present invention seeks to solve is to design an optical sensor of the type mentioned at the beginning such that it has a compact structure that can be easily mounted.

The features of claim 1 are provided to solve this problem. Advantageous embodiments and useful further developments of the invention are described in the dependent claims.

The invention relates to an optical sensor for detecting objects, with a housing in which electronic components and at least one sensor component are stored. One of the electronic components generates an output signal in dependence upon sensor signals of the sensor component or a sensor component. A printed circuit board is present as electronic component, wherein the sensor component is arranged lying in a tube on a side forming an assembly side. The tube is fastened with fastening means that are all arranged on or at the assembly side and are mountable on the assembly side.

An essential advantage of the invention is that not only the sensor component can be mounted on the assembly side of the printed circuit board. Rather, the tube in which the sensor component is stored can be completely mounted on the assembly side of the printed circuit board. This is achieved according to the invention in that the fastening means for fastening the tube to the printed circuit board are not merely arranged completely on or at the assembly side of the printed circuit board. Rather, the fastening means can also be completely actuated on this assembly side for fastening the tube to the printed circuit board.

This results in an essential advantage that the side opposite the assembly side can form a component side, which is completely free for fitting with components, i.e. electronic components.

Thus a compact structure of the optical sensor can be realized.

According to an advantageous embodiment, the sensor component stored in the tube is an image sensor.

In this context, it is advantageous for a lens to be arranged in the tube in front of the image sensor.

The image sensor, i.e. imager, can be formed, for example, by a matrix-shaped CMOS or CCD array, the lens consists of a lens arrangement in the known manner.

In this case, the optical sensor can be designed as a code reader with which barcodes and 2D codes can be detected.

In such an optical sensor, it is expedient for light-beam emitting light-emitting diodes which form an illumination unit to be arranged on the assembly side of the printed circuit board.

The field of view of the image sensor is lit up with the light beams of the illumination unit.

Advantageously, a computer unit which constitutes an evaluation unit is arranged on the component side of the printed circuit board as an electronic component.

The sensor signals of the sensor component or a sensor component are evaluated in the evaluation unit for generating the output signal.

The computer unit can be designed as a microcontroller, in particular.

As a large and flat component, the microcontroller can also be arranged on the component side of the printed circuit board, since according to the invention no fastening means are present on the component side.

Especially advantageously, the microcontroller is arranged opposite the image sensor mounted in the tube.

Advantageously, the image sensor is connected to the microcontroller forming the evaluation unit by MIPI lines. MIPI lines are serial interface lines standardized by the MIPI consortium with high data transmission rates.

The MIPI lines can have short line lengths since the image sensor can be arranged directly opposite the microcontroller, which is an essential prerequisite for disturbance-free data transmission between image sensor and microcontroller.

According to an embodiment advantageous from a design perspective, the tube has guide pins for centering on the printed circuit board. The guide pins can be inserted into blind centering boreholes which open out on the assembly side of the printed circuit board.

The blind centering boreholes can be worked in exactly at the target positions in the printed circuit board using a calibration process for mounting the optical sensor, in particular by means of image processing methods. This ensures that by inserting the guide pins into the blind centering borehole, the tube is exactly positioned.

According to a first variant of the invention, the guide pins form fastening means for fastening the tube to the printed circuit board. The guide pins are then fixed in the blind centering boreholes by adhesive connections.

From a design perspective, this is an especially simple way to fasten the tube to the assembly side of the printed circuit board, since in this case it is not necessary to provide separate fastening means, but rather the centering means can be used for fastening the tube. Especially advantageously, the fastening of the tube can take place without tools. The only prerequisite for such fastening is that the tube consists of a glueable material.

According to a second variant of the invention, an annular bracket with latching means projecting from its top is fastened on the assembly side. The tube can be fastened sitting up on the assembly side of the printed circuit board by means of the latching means.

In this context, the bracket is fixed on the assembly side of the printed circuit board by means of a soldered connection or an adhesive connection.

Thus the bracket required for fastening the tube to the assembly side can be fastened by soldering or gluing, i.e. in this case there are no fastening means present on the component side and the bracket can be mounted on the printed circuit board from the assembly side.

The fastening of the tube itself can be done without tools by simple latching into the latching means of the bracket.

According to an embodiment advantageous from a design perspective, a rotationally symmetric arrangement of identically designed latching means is provided in the circumferential direction of the annular bracket.

This results in a stable and uniform fastening in the circumferential direction of the tube.

Expediently, the latching means are designed in the shape of spring-loaded hooks.

The spring-loaded hooks form easily actuable latching means and with the spring forces of the hooks ensure a stable hold of the tube to the bracket.

Expediently, the bracket with the latching means is formed by a sheet metal part.

This allows the bracket to be produced cost effectively and efficiently.

According to an advantageous embodiment, the tube has a hollow-cylindrical base body. On its bottom is an annular pedestal projecting beyond the outer jacket surface of the base body.

In this case, the tube is fastened to the assembly side of the printed circuit board in that the latching means are in engagement with the pedestal.

With the pedestal, a seating for the latching means is provided in a simple manner.

According to a third variant of the invention, the printed circuit board has blind holes opening out on its assembly side, in which blind holes a threaded bushing is respectively mounted. For fixing the tube to the printed circuit board, screws mounted in seatings of the tube are screwed into the threaded bushings.

In this case also, the fastening means are on the assembly side of the printed circuit board and can be actuated there for fastening the tube.

Advantageously, the threaded bushings are soldered into the blind holes.

Thus the fastening of the threaded bushings can take place solely on the assembly side of the printed circuit board.

According to an embodiment advantageous from a design perspective, the tube has a hollow-cylindrical base body. An annular projection in which the screws are mounted opens out on the bottom of the base body.

In this context, the screws are mounted in bore holes on the top of the annular projection.

The screws are thus accessible on the assembly side of the printed circuit board for fastening the tube.

### BRIEF DESCRIPTION OF THE DRAWINGS

The invention is explained in the following with regard to the drawings. They show:

FIG. 1: A schematic depiction of an exemplary embodiment of the optical sensor according to the invention.

FIG. 2: A first exemplary embodiment of a tube fastening for the optical sensor according to FIG. 1.

FIG. 3: A second exemplary embodiment of a tube fastening for the optical sensor according to FIG. 1.

FIG. 4: A third exemplary embodiment of a tube fastening for the optical sensor according to FIG. 1.

### Detailed Description of the Preferred Embodiments

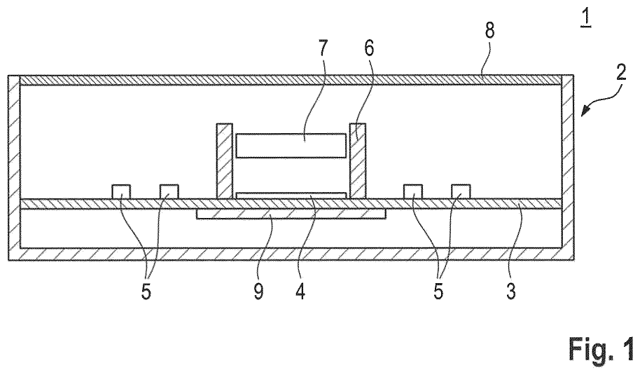

FIG. 1 shows a highly schematized and not to scale embodiment example of the optical sensor 1 according to the invention. In the present case, the optical sensor 1 is designed as a code reader by means of which barcodes and 2D codes can be detected.

The electronic components and sensor components of the optical sensor 1 are integrated into a housing 2 consisting of an opaque material.

As the central electronic component, a printed circuit board 3 is mounted in the housing 2. An image sensor 4 and multiple light-emitting diodes 5 surrounding the image sensor 4 are mounted on an assembly side of the printed circuit board 3 as sensor components. The image sensor 4 is formed from a matrix-shaped CCD or CMOS array, for example. The light-beam emitting light-emitting diodes 5 form an illumination unit with which the field of view of the image sensor 4 is lit up.

The image sensor 4 is located in an essentially hollow-cylindrical tube 6 consisting of opaque material. In the tube 6, a lens 7 is mounted in front of the image sensor 4 for focussing light beams onto the image sensor 4.

A pane 8 consisting of transparent material, i.e. material through which the light beams can pass, is mounted in a front wall of the housing 2.

A microcontroller 9 which forms an evaluation unit is mounted on a component side opposite the assembly side. Instead of a microcontroller 9, another computer unit can also be provided.

The light beams emitted by the light-emitting diodes 5 are guided through the pane 8 into a detection area. From a code applied to an object, light beams are guided to the image sensor 4 via the pane 8 and the object. The sensor signals generated by the image sensor 4 in this context are evaluated in the evaluation unit. In this context, the code is decoded in the evaluation unit based on the code information contained in the sensor signals and the code is output as output signal by optical sensors 1.

According to the invention, the tube 6 is fastened to the assembly side of the printed circuit board 3 with fastening means arranged exclusively on or at the assembly side and can be actuated from the assembly side of the printed circuit board 3, such that the entire assembly of the tube 6 takes place at the assembly side of the printed circuit board 3. The component side is thus completely free for electronic components, i.e. components.

This is exploited, in particular, in that the image sensor 4 and the microcontroller 9 are disposed on opposite sides of the printed circuit board. Thereby the image sensor 4 and the microcontroller 9 can be connected via very short (not shown) MIPI lines, such that disturbance-free data transmission can take place between image sensor 4 and microcontroller 9.

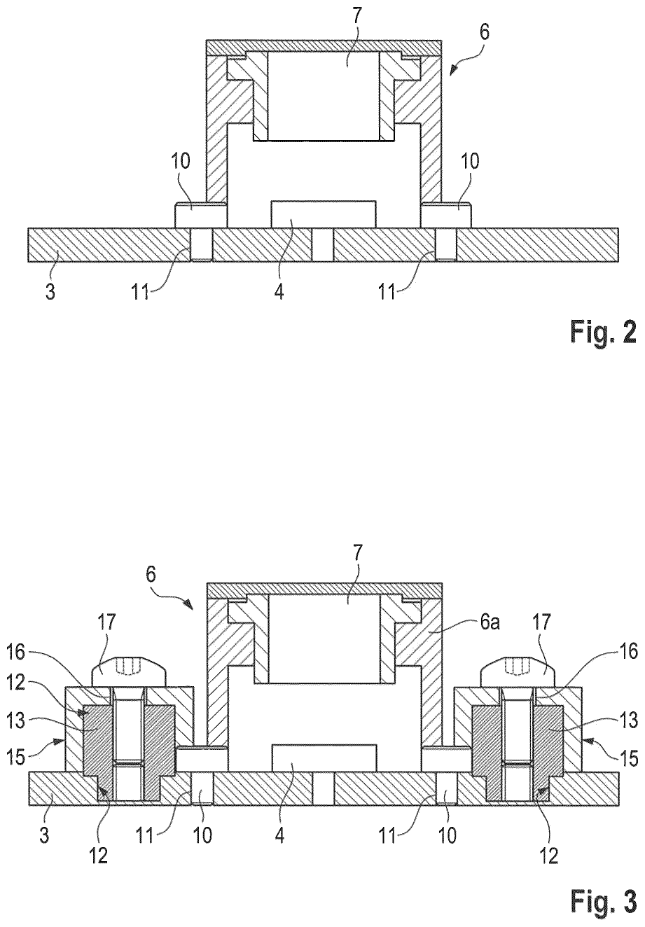

FIG. 2 shows a first exemplary embodiment of the tube fastening according to the invention.

FIG. 2 shows a cutout of the printed circuit board 3 of the optical sensor 1 with an image sensor 4 arranged on its assembly side. The image sensor 4 like the lens 7 is arranged in the tube 6.

Guide pins 10 open out on the lower edge of the tube 6, which advantageously are arranged at identical distances in the circumferential direction.

The guide pins 10 are inserted into blind centering boreholes 11 of the printed circuit board 3, wherein the blind centering boreholes 11 open out on the assembly side of the printed circuit board 3. The blind centering boreholes 11 are worked into the printed circuit board 3 in advance in a calibration process. Once the guide pins 10 of the tube 6 are then inserted into the blind centering boreholes 11, the tube 6 is exactly centered in its target position on the printed circuit board 3.

In the present case, the guide pins 10 also form the fastening means for fastening the tube 6, for this purpose adhesive connections are produced between the guide pins 10 and the wall segments of the blind centering boreholes 11.

The prerequisite for this is that the tube 6 consists of glueable material.

FIG. 3 shows a second exemplary embodiment of the tube fastening according to the invention, wherein FIG. 3 again shows a cutout of the printed circuit board 3 with image sensor 4 and tube 6 mounted on top of the printed circuit board 3.

According to the exemplary embodiment according to FIG. 2, again guide pins 10 are provided on the bottom of the tube 6, which guide pins 10 engage in blind centering boreholes 11 of the printed circuit board 3. However, in this case the guide pins 10 only serve for centering the tube 6 and not for fastening the tube.

In the present case, blind holes 12 which open out on the assembly side of the printed circuit board 3 are worked into the printed circuit board 3 for fastening the tube. Threaded bushings 13 are soldered into the blind holes.

The tube 6 has a hollow-cylindrical base body 6a, on the bottom of which an annular projection 15 opens out. Boreholes 16 are worked into the top of the annular projection 15. The boreholes 16 are arranged equidistant in the circumferential direction of the tube 6 and form an arrangement that is rotationally symmetric relative to the axis of symmetry of the tube 6.

A screw 17 is mounted in each bore hole 16.

The tube fastening is done such that a screw 17 is screwed into each threaded bushing 13.

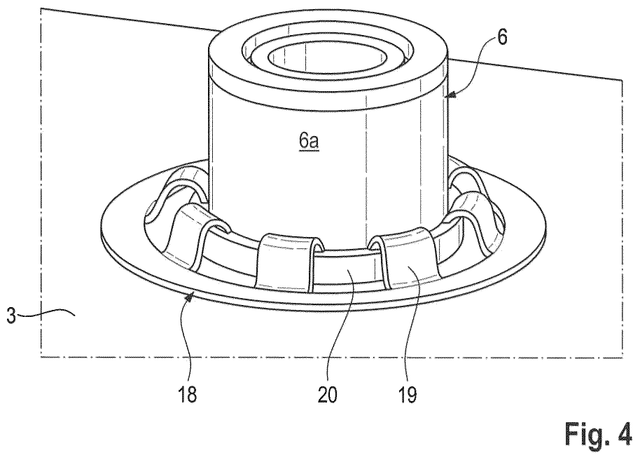

FIG. 4 shows a third exemplary embodiment of the tube fastening according to the invention. In this context, FIG. 4 shows a cutout of the printed circuit board 3 with the tube mounted on top of it.

In the present case, the tube fastening is done by means of an annular bracket 18 having latching means, which is fixed to the assembly side of the printed circuit board 3 by a soldered or adhesive connection.

The latching means are formed monolithically with the bracket 18 and from a sheet metal part. In the present case, the latching means are formed by spring-loaded hooks 19. The identically designed hooks 19 are arranged equidistant in the circumferential direction of the bracket 18 and form a rotationally symmetric arrangement. The hooks 19 open out on the top of the bracket 18.

Adapted thereto, the tube 6 has a hollow-cylindrical base body 6a, on the bottom of which an annular pedestal 20 which projects from the outer jacket surface of the base body 6a connects. The tube 6 can be mounted on the printed circuit board 3 with the bottom of the pedestal 20.

For fastening the tube 6, it is inserted with the pedestal 20 into the annular bracket 18. In this context, the spring-loaded hooks 19 spring back, such that the pedestal 20 can be seated on the printed circuit board 3. Once the pedestal 20 of the tube 6 is seated on the printed circuit board 3, the hooks 19 spring back and abut the top of the pedestal 20 with contact pressure, by which the tube 6 is positionally fixed at its target position on the printed circuit board 3.

### LIST OF REFERENCE NUMERALS

(1) Optical sensor
(2) Housing
(3) Printed circuit board
(4) Image sensor
(5) Light-emitting diodes
(6) Tube
(6a) Base body
(7) Lens
(8) Pane
(9) Microcontroller
(10) Guide pin
(11) Blind centering boreholes
(12) Blind hole
(13) Threaded bushing
(15) Lug
(16) Borehole
(17) Screw
(18) Bracket
(19) Hook
(20) Pedestal

1. An optical sensor (1) for detecting objects, having a housing (2) in which electronic components and at least one sensor component are mounted, wherein at least one electronic component generates an output signal in dependence upon sensor signals of the sensor component or a sensor component, characterized in that a printed circuit board (3) is present as electronic component, wherein on a side forming an assembly side, the sensor component is arranged in a tube (6), and wherein the tube (6) is fastened with fastening means which are all arranged on or at the assembly side and can be mounted on the assembly side.

2. The optical sensor (1) according to claim 1, characterized in that the sensor component mounted in the tube (6) is an image sensor (4), wherein a lens (7) is arranged in the tube in front of the image sensor (4).

3. The optical sensor (1) according to claim 1, characterized in that light-beam emitting light-emitting diodes (5), which constitute an illumination unit, are mounted on the assembly side of the printed circuit board (3), and/or in that the side of the printed circuit board (3) opposite the assembly side is a component side on which electronic components are arranged.

4. The optical sensor (1) according to claim 3, characterized in that a computer unit is arranged on the component side of the printed circuit board (3) as an electronic component which forms an evaluation unit in which the sensor signals of the sensor component or a sensor component are evaluated for generating the output signal.

5. The optical sensor (1) according to claim 1, characterized in that the tube (6) has guide pins (10) for centering on the printed circuit board (3), which guide pins (10) can be inserted into blind centering boreholes (11) which open out on the assembly side of the printed circuit board (3).

6. The optical sensor (1) according to claim 5, characterized in that the guide pins (10) form fastening means for fastening the tube (6) on the printed circuit board (3), in that the guide pins (10) are fixed in the blind centering boreholes (11) by adhesive connections.

7. The optical sensor (1) according to claim 1, characterized in that an annular bracket (18) with latching means projecting from its top is fastened on the assembly side, and in that the tube (6) can be fastened onto the assembly side of the printed circuit board (3) by means of the latching means.

8. The optical sensor (1) according to claim 7, characterized in that a rotationally symmetric arrangement of identically designed latching means is provided in the circumferential direction of the annular bracket (18).

9. The optical sensor (1) according to claim 7, characterized in that the latching means are designed in the form of spring-loaded hooks (19).

10. The optical sensor (1) according to claim 7, characterized in that the bracket (18) with the latching means is formed by a sheet metal part, and/or in that the bracket (18) is fixed on the assembly side of the printed circuit board (3) by means of a soldered or adhesive connection.

11. The optical sensor (1) according to claim 7, characterized in that the tube (6) has a hollow-cylindrical base body (6a) on the bottom of which an annular pedestal (20) projecting beyond the outer jacket surface of the base body (6a) is present, wherein the tube (6) is fastened to the assembly side of the printed circuit board (3) in that the latching means are in engagement with the pedestal (20).

12. The optical sensor (1) according to claim 1, characterized in that the printed circuit board (3) has blind holes that open out on its assembly side, in which holes a threaded bushing (13) is respectively mounted, and in that for fixing the tube (6) to the printed circuit board (3), screws (17) mounted in seatings of the tube (6) are screwed into the threaded bushings (13).

13. The optical sensor (1) according to claim 12, characterized in that the threaded bushings (13) are soldered into the blind holes.

14. The optical sensor (1) according to claim 12, characterized in that the tube (6) has a hollow-cylindrical base body (6a) on the bottom of which an annular projection (15) opens out in which the screws (17) are mounted, wherein the screws (17) are mounted in boreholes (16) on the top of the annular projection (15).

15. The optical sensor (1) to claim 1, characterized in that it is a code reader.
